(19) United States
(12) Patent Application Publication
(10) Pub. No.: US 2001/0017665 A1
(43) Pub. Date: Aug. 30, 2001

(54) Actuator having a sphere and piezoelectric drives

(76) Inventors: Bernd Ackermann, Aachen (DE); Gerhard Diefenbach, Aachen (DE); Astrid Lewalter, Aachen (DE); Christian Reichinger, Alsdorf (DE)

Correspondence Address: Corporate Patent Counsel, U.S Philips Corporation, 580 White Plains Road, Tarrytown, NY, 10591, US

(21) Appl. No.: 09/741,655

(22) Filed: Dec. 19, 2000

(30) Foreign Application Priority Data
Dec. 21, 1999 (DE) 19961684.1

(51) Int. Cl. H04N 5/225

(52) U.S. Cl. 348/374; 348/373; 348/375

(57) ABSTRACT

The invention relates to an actuator having a plurality of piezoelectric drives (1a, 1b, 1c) and a sphere (2) which is rotatable about at least two axes of rotation (7a, 7b, 7c), and to an arrangement for transmitting pictures and sound, including an actuator. The actuator should be flexible in use and is to be realized at minimal cost. For this purpose, at least two piezoelectric drives (1a, 1b, 1c) have been provided which can rotate the sphere (2) arbitrarily, the piezoelectric drives (1a, 1b, 1c) being capable of transmitting their power to the sphere (2) in order to rotate this sphere about a respective axis of rotation by friction with the aid of vibrations in a tangential direction relative to the surface of the sphere (2).

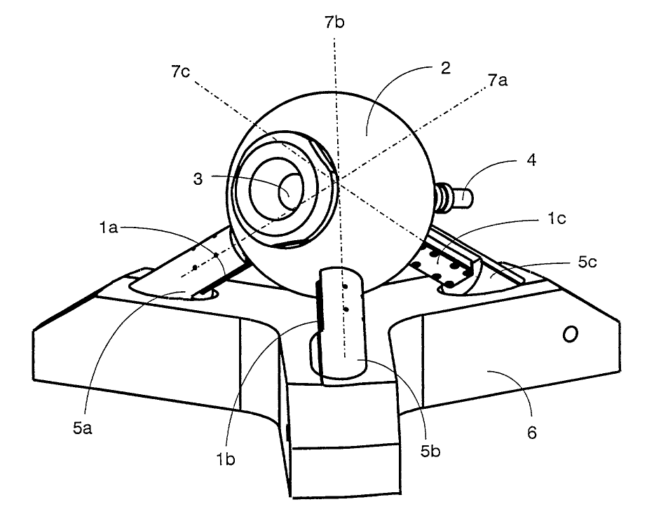

The invention relates to an actuator having a plurality of piezoelectric drives and a sphere which is rotatable about at least two axes of rotation, and to a camera arrangement as well as an arrangement for transmitting pictures and sound which include an actuator.

Buildings are often surveyed around the clock by video cameras. For this purpose, numerous video cameras are arranged inside and outside this building to cover the desired areas. These video cameras are mounted on pan-and-tilt mechanisms which can be panned and tilted by means of electric motors in order to provide a maximal surveillance range for the video camera. These pan en tilt mechanisms require much room and, for example, do not allow flush mounting in a wall. Moreover, electric drive motors only permit a smooth and continuous rotary movement of the video camera with the aid of an intricate mechanism, they require a comparatively large amount of electric power and they need regular maintenance. This mechanical intricate solution leads to a high price and is therefore not attractive for mass production.

Alternatives for electric drive motors are inter alia piezoelectric actuator drives, which permit a continuous and effectively controllable rotary movement and require minimal maintenance. However, piezoelectric actuator drives require a given contact pressure because they transmit their power through friction.

It is an object of the present invention to provide an actuator which is flexible in use and which can be realized at minimal cost.

According to the invention this object is achieved in that at least two piezoelectric drives have been provided in order to rotate the sphere about at least two axes of rotation, the piezoelectric drives being capable of transmitting their power to the sphere in order to rotate this sphere about a respective axis of rotation by friction with the aid of vibrations in a tangential direction relative to the surface of the sphere.

Thus, it is possible to obtain a spatial rotation of the sphere by means of only two piezoelectric drives, which are equivalent to two different spatially rigid axes of rotation, and a third low-friction ball-bearing-mounted fulcrum. The tangential power transmission of the piezoelectric drives further enables a high torque to be obtained because the whole radius of the sphere is available as a lever arm.

Moreover, it is proposed to use coupled-resonance piezoelectric motors (CRP) as piezoelectric drives, which motors transmit their power to the surface of the sphere in a tangential direction in a first mode of operation, which perform longitudinal vibrations in a second mode of operation, and which can immobilize the sphere in the last position reached in a self-braking manner in the switched-off state.

The first mode of operation enables the sphere to be rotated, while the second mode of operation has the advantage that the longitudinal vibrations reduce the friction between a non-rotating piezoelectric motor and the sphere. This improves the positioning accuracy of the sphere and reduces the required power rating of the piezoelectric motors. When the piezoelectric motors are turned off the friction between motor and sphere precludes an inadvertent change in position of the sphere.

In a further embodiment of the invention the piezoelectric motors are arranged inside the sphere and power is transmitted from the piezoelectric motors to the inside of a shell which surrounds the sphere.

This embodiment of an actuator is advantageous when the sphere is large and the piezoelectric motors have enough room inside the sphere. Apart from the sphere and the shell surrounding it no mounting elements are needed for piezoelectric motors, as a result of which the overall size of the actuator is reduced to the size of the surrounding shell.

In a further embodiment of the invention the piezoelectric motors are arranged in such a manner that three orthogonal axes of rotation are available and three piezoelectric motors are controlled in such a manner that a first piezoelectric motor performs a rotary movement about an axis of rotation, while a second piezoelectric motor, whose tangential plane of vibration extends parallel to this axis of rotation, reduces the friction in the fulcrum of the sphere, which fulcrum is associated with the second motor, and a third piezoelectric motor, disposed in the axis of rotation, stabilizes the axis of rotation in the fulcrum of the sphere in the switched-off state of this third motor, with which this fulcrum is associated.

This particularly advantageous embodiment enables a particularly simple control of the rotary movement of the sphere because here always only one piezoelectric motor rotates about one of the three orthogonal spatially rigid axes of rotation. At the same time, a switched-off motor ensures that the axis of rotation about which a rotation is taking place is stabilized in the fulcrum of this motor. This results in a greater precision of the rotary movement. The third motor that has been provided then performs longitudinal vibrations, as a result of which the friction existing between this motor and the sphere is minimized. This is because the longitudinal vibrations cause the sphere to be lifted off the vibrating piezoelectric motor. The orthogonal arrangement of the axes of rotation simplifies the coordination during rotary movements composed of rotations about a plurality of axes of rotation.

Moreover, the sphere exerts a contact pressure on the piezoelectric motors, which contact pressure is provided by the weight of the sphere itself, by a magnet or by a second sphere mounted on the sphere to be rotated.

If the weight of the sphere cannot provide an adequate contact pressure on the piezoelectric motors, the contact pressure can be increased by means of a magnet or a ball-bearing. A higher contact pressure leads to a more reliable power transmission, as a result of which the rotary movements are performed more exactly.

It is further advantageous to equip an arrangement for recording pictures and/or sound with an actuator in accordance with one of the above embodiments, its sphere being adapted to accommodate a camera and/or a microphone.

A video camera for the transmission of pictures and sound can thus be rotated and directed precisely. Also in this case the wear-free piezoelectric motors have the great advantage, as compared with conventional electric motors, that in the switched-off state they can lock the video camera in a non-moving condition without any further means.

Embodiments of the invention will be described in more detail, by way of example, with reference to a figure.

The figure shows an arrangement including a digital video camera 3, which is connected to a PC, a television set or a videophone and which can be pivoted in all directions.

During, for example, video conferencing or when making video mails this makes it possible for the camera to follow the user in a space, as a result of which this user need not sit down in front of the camera but can move freely in the space. The digital video camera 3 and, if desired, a microphone, which is not shown in the figure, are mounted in a sphere 2 of a metal or another material having a shock-resistant hard surface. It is also possible to install a sensor, for example an infrared sensor, by means of which the camera tracks a source of heat, for example for surveillance purposes. The sphere 2 has a recess for accommodating the video camera 3 and, if desired, the microphone, as well as a lead-through 4 for a cable for the power supply and for the data exchange. The sphere is supported in three points on three piezoelectric motors 1a, 1b, 1c.

The piezoelectric motors 1a, 1b, 1c are so-called coupled-resonance piezoelectric motors (CRP), a special version of piezoelectric miniature drives. The vibrating members of these piezoelectric motors consist of a rectangular plate. The exact operation of the coupled-resonance piezoelectric motors is described in the document DE 198 17 038. The use of piezoelectric motors of the CRP type has the advantage that they can operate in two modes. Depending on how they are driven these piezoelectric motors can, firstly, rotate the sphere 2 by resulting vibrations in tangential directions with respect to the sphere surface and, secondly, generate longitudinal vibrations in radial directions with respect to the sphere 2. As a result of this, the sphere 2 is lifted off the longitudinally vibrating piezoelectric motor and floats substantially without mechanical contact and friction. It is important that both modes can be excited by means of the same resonant circuit.

The piezoelectric motors 1a, 1b, 1c are arranged in an orthogonal tripod 5a, 5b, 5c. They are supported in guide means and resilient supports so as to allow a free and unimpeded vibration of the piezoelectric motors 1a, 1b, 1c. All the axes of rotation 7a, 7b, 7c are oriented perpendicularly to one another. Thus, the rotation of the sphere 2 about spatially rigid axes of rotation 7a, 7b, 7c can be effected in a particularly advantageous manner. A first piezoelectric motor, for example the motor 1a, rotates the sphere, while a second piezoelectric motor 1b, which is disposed in the same plane perpendicular to the axis of rotation 7cand whose friction would have to be overcome by the first motor 1a, is set to a pure longitudinal vibration mode in order to reduce the friction. A third piezoelectric motor 1c, whose fulcrum is disposed exactly in the instantaneous axis of rotation 7c, has a braking action only when the axis of rotation 7c changes with respect to the sphere 2. Thus, in its switched-off state the third motor 1c serves to stabilize the axis of rotation 7c and to preclude a deviation of the sphere 2 from the desired axis of rotation 7c. In this way, any one of the three motors 1a, 1b, 1c can rotate the sphere 2 about an associated axis of rotation, the other two motors then acting, respectively, to stabilize the axis of rotation and to reduce the friction.

It is alternatively possible to arrange the piezoelectric motors 1a, 1b, 1c inside the sphere 2, their power then being transmitted to a shell which surrounds the sphere 2. Since piezoelectric motors transmit their power through friction an adequate contact pressure is required between the sphere 2 and the piezoelectric motors 1a, 1b, 1c. This contact pressure is provided by the sufficiently high weight of the sphere 2, which presses the sphere 2 with its surface onto the piezoelectric motors 1a, 1b, 1c and thus provides the required friction.

When the weight of the sphere 2 is not high enough the contact pressure can be increased in that a magnet is mounted underneath the sphere 2 between the tripod 5a, 5b, 5c of the piezoelectric motors 1a, 1b, 1c, which magnet subjects the sphere 2, which is now made of a metal, to a force of attraction. In case that the sphere 2 is made of another hard material such as for example a ceramic material, a small iron core inside the sphere 2 is adequate to provide the force of attraction. Another possibility of producing an adequate contact pressure is to provide a second sphere arranged above the sphere 2, which second sphere thus bears on the piezoelectric motors 1a, 1b, 1c from above. Furthermore, an air bearing may be envisaged, where air is forced between the sphere 2 and a bearing above the sphere 2 by means of a compressor so as to provide the necessary contact pressure. When the sphere 2 is not moved the whole arrangement brakes itself as a result of the friction between the sphere surface and the piezoelectric motors 1a, 1b, 1c. Thus, no electric power is consumed upon stopping and no additional locking mechanisms are needed.

In comparison with known actuators the present invention has the major advantage that the CRP type piezoelectric motors enable two modes of operation to be performed by means of one motor and that the mode in which longitudinal vibrations are generated allows a rotation of the sphere 2 by means of only one piezoelectric motor without this motor having to overcome a substantial frictional force of the non-rotating motors. This permits a smooth and continuous rotary movement requiring little power and it reduces the required power and consequently the current consumption.

1. An actuator having a plurality of piezoelectric drives (1a, 1b, 1c) and a sphere (2) which is rotatable about at least two axes of rotation, characterized in that at least two piezoelectric drives (1a, 1b, 1c) have been provided in order to rotate the sphere (2) about at least two axes of rotation (7a, 7b, 7c), the piezoelectric drives (1a, 1b, 1c) being capable of transmitting their power to the sphere (2) in order to rotate this sphere about a respective axis of rotation by friction with the aid of vibrations in a tangential direction relative to the surface of the sphere (2).

2. An actuator as claimed in claim 1, characterized in that coupled-resonance piezoelectric motors are used as piezoelectric drives (1a, 1b, 1c), which motors transmit their power to the surface of the sphere (2) in a tangential direction in a first mode of operation, which perform longitudinal vibrations in a second mode of operation, and which can immobilize the sphere (2) in the last position reached in a self-braking manner in the switched-off state.

3. An actuator as claimed in claim 1 or 2, characterized in that the sphere (2) is arranged in a shell which surrounds it, the piezoelectric drives (1a, 1b, 1c) are arranged inside the sphere (2), and power is transmitted from the piezoelectric drives (1a, 1b, 1c) to the inside of the shell.

4. An actuator as claimed in claims 1 to 3, characterized in that three orthogonal axes of rotation (7a, 7b, 7c) are available, three piezoelectric drives (1a, 1b, 1c) are controlled in such a manner that a first piezoelectric drive performs a rotary movement about an axis of rotation, while a second piezoelectric drive, whose tangential plane of vibration extends parallel to this axis of rotation, reduces the friction in the fulcrum of the sphere (2), which fulcrum is associated with the second drive, and a third drive, disposed in the axis of rotation, stabilizes the axis of rotation in the fulcrum of the sphere (2) in the switched-off state of this third drive with which this fulcrum is associated.

5. An actuator as claimed in claims 1 to 4, characterized in that a contact pressure is exerted on the piezoelectric drives (1a, 1b, 1c) by the sphere (2), which contact pressure is provided by the weight of the sphere (2) itself, by a magnet or by a second sphere mounted on the sphere (2) to be rotated.

6. An arrangement for picking up pictures and/or sound, including an actuator as claimed in any one of the claims 1 to 5, characterized in that the sphere (2) of the actuator is adapted to accommodate a camera (3) and/or a microphone.
